(19) United States
(12) Patent Application Publication
(10) Pub. No.: US 2009/0145276 A1
(43) Pub. Date: Jun. 11, 2009

(54) CUTTING TOOL FOR CUTTING LABELS

(75) Inventors: Josef Scheck, Mangolding (DE); Stefan Scherl, Neunburg vorm Wald (DE)

Correspondence Address: RISSMAN HENDRICKS & OLIVERIO, LLP, 100 Cambridge Street, Suite 2101, BOSTON, MA, 02114, US

(73) Assignee: KRONES AG, Neutraubling (DE)

(21) Appl. No.: 12/327,101

(22) Filed: Dec. 3, 2008

(30) Foreign Application Priority Data
Dec. 5, 2007 (DE) 10 2007 058 816.1

(51) Int. Cl. B23D 25/02

(52) U.S. Cl. 83/337

(57) ABSTRACT

A cutting tool for cutting labels may include a housing arranged such that it can rotate about a rotation axis and a cutting element detachably arranged on the housing. The cutting element may have a cutting edge extending substantially in a direction parallel to the rotation axis. The cutting element may be arranged such that it can move relative to the housing. A first spring body may be structured and arranged to cushion a movement of the cutting element in a radial direction of the housing.

### CROSS-REFERENCE TO RELATED APPLICATION

This application claims the benefit of priority of German Patent Application No. 10 2007 058 816.1, filed Dec. 5, 2007, pursuant to 35 U.S.C. 119(a)-(d), the disclosure of which is incorporated herein by reference in its entirety as if fully set forth herein.

### TECHNICAL FIELD

The present disclosure relates to a cutting tool for cutting labels and also to a cutting apparatus for cutting labels.

### BACKGROUND

In some conventional systems, labels are glued onto containers and in particular bottles. For this, endless rolls comprising labels are provided, and these endless rolls are drawn onto a counter-cutting roller. These endless labels are then cut into individual labels and glued onto the containers. In order to cut these label strips, these counter-cutting rollers have counter-cutting channels which in turn cooperate with blades, wherein these blades are arranged on a further cutting rotor. In this case it is necessary for the cutting blades to be arranged as precisely and as parallel as possible relative to the cutting channels so that the cutting operation can be carried out cleanly. In these conventional systems, however, the problem arises that excessive or one-sided wear of the cutting blades may occur and the latter can then no longer correctly perform their function.

A labelling machine for labelling containers is known from the German publication DE 20/2005 002 793 U1. In this document, a cutting device is formed by a rotating vacuum roller and a rotating cutting element, wherein this cutting element has on its outer circumference at least one cutting tool and in particular a cutting blade. It is noted therein that the cutting element is arranged in a spring-mounted manner in the respective cutting tool in order to be able to carry out the cutting operation in a gentle manner. However, DE 20/2005 002 793 does not mention how this spring-mounted arrangement is configured, or in which spatial direction the spring mounting is performed.

An apparatus for fixing blades in perforating and cutting cylinders is known from the German publication DE 42 09 752 C2. In this document, use is made of an inflatable compressed air chamber which securely clamps a blade in a channel of a cylinder.

It may therefore be desirable to provide a spring mounting for a cutting element which is configured in such a way that a cutting operation for a labelling machine can be carried out in a manner which is gentler on the cutting blade.

### SUMMARY OF THE INVENTION

A cutting tool according to the invention, which is provided in particular for cutting labels, comprises a housing which can rotate about a rotation axis and a cutting element which is arranged on this housing. This cutting element has a cutting edge which extends essentially in a direction parallel to the rotation axis, and the cutting element is arranged detachably on the housing.

According to the invention, the cutting element is arranged such that it can move relative to the housing, and a first spring body is provided which cushions a movement of the cutting element in an essentially radial direction of the housing.

The radial direction of the housing or rotor is understood here to mean a radial direction relative to the rotation axis, about which the housing rotates. One-sided wear of the spring element can be counteracted by this spring mounting of the cutting element in the radial direction of the housing. The radial direction of the housing is understood to mean, in addition to a geometrically precise radial direction of the housing which extends from the cutting element to the rotation axis, also those directions which run parallel to this radial direction. A spring mounting in the radial direction is also understood to mean those spring mountings which have a directional component in the radial direction. Accordingly, for example, even a cutting element which is spring-mounted in an oblique direction relative to the radial direction would also have a movement in the radial direction and thus would also be spring-mounted in the radial direction of the housing.

In other words, the spring body may be arranged further inwards than the cutting element in a radial direction of the housing. The spring body may be arranged between the cutting element and the rotation axis on a geometric line between a region of the cutting element and the rotation axis. However, it would also be possible that the spring body is offset laterally relative to this geometric line. The cutting tool can rotate through 360°; however, it would also be possible to permit only smaller angles of rotation.

In an exemplary embodiment, the spring body is arranged between the two end sections of the cutting element in the direction of the rotation axis. The spring body may thus be provided in the interior of the housing.

In an exemplary embodiment, the spring body comprises a gas-filled spring element. More specifically, the spring body here comprises an air cushion which, when subjected to the action of compressed air, in turn exerts a force on the cutting element. Through the choice of pressure of this compressed air, the preloading force of the cutting element in the radially outward direction can also be adjusted. Due to this mounting of the spring element, it is possible to achieve the situation whereby only a predefined maximum force is applied by the spring element and the cutting element springs back if a greater force is applied. It is thus possible to choose a force which is sufficient to cut the labels but is low enough to prevent premature wear of the cutting element and in particular of the cutting edge. According to some aspects, the labels are not cut in the proper sense of the word but rather are “pressed through” by the cutting tool according to the disclosure.

One further development of the disclosure comprises configuring the spring body such that it is continuously supplied with air. This means that the spring body is constantly in contact with an air supply which, if necessary, may be compressed air. The air supply may be adjustable so that different spring properties can be achieved in the spring body by generating different pressures.

In an exemplary embodiment, the cutting element is arranged in a recess provided on an outer circumference of the housing. This recess may extend radially inwards.

According to some aspects, a support is provided between the cutting element and the first spring body, which support makes contact with the cutting element and the first spring body. The cutting element is thus not contacted directly by the first spring body, but rather the force which the spring body applies to the cutting element is transmitted via the support. By virtue of this support, the guidance of the cutting element can be improved.

In an exemplary embodiment, the cutting tool has a second spring body which preloads or fixes the cutting element relative to the housing in a circumferential direction of the housing. In this embodiment, the cutting element is located in the abovementioned groove of the housing or of the cutting rotor. Via this second spring body and also via a pressure strip, the cutting element may be clamped as soon as air is applied to the second spring body.

In an exemplary embodiment, the second spring body thus also comprises a gas-filled spring element. The second spring body is supplied with continuous air which may be introduced into the rotating housing through a rotary distributor.

In an exemplary embodiment, the cutting tool has a plurality of first spring bodies arranged one behind the other in the direction of the rotation axis. The force acting on the cutting element is thus distributed between a plurality of the aforementioned spring bodies.

In an exemplary embodiment, a section of the abovementioned support is arranged between the cutting element and the second spring body. In this embodiment, therefore, the support comprises two sections which are located between the respective first and second spring bodies and the cutting element.

In this embodiment, the support may have an L-shaped cross section.

In an exemplary embodiment, the cutting tool has a supply device for supplying the spring element with gas and in particular with compressed air. As mentioned above, this compressed air results on the one hand in the spring-mounting of the cutting element in the radial direction and also in a clamping of the cutting element in the housing.

In an exemplary embodiment, the supply device is configured in such a way that it supplies the spring element with gas continuously during an operating state. The cutting element is thus fixed in the housing specifically as a result of this gas supply.

In an exemplary embodiment, at least one spring body has a flexible membrane. The respective forces are applied to the cutting element via this membrane.

The present disclosure also relates to a cutting apparatus, in particular for cutting labels, wherein this cutting apparatus comprises a cutting tool of the type discussed above and a counter-cutting roller which cooperates with this cutting tool.

Further advantages and embodiments will emerge from the appended drawings.

### BRIEF DESCRIPTION OF THE DRAWINGS

In the drawings:

FIG. 1 shows a schematic diagram of an apparatus according to the invention for cutting labels;

FIG. 2 shows a detailed diagram of a cutting tool according to the invention;

FIGS. 3a-3d show four views of a cutting tool according to the invention;

FIG. 4 shows a perspective diagram of one element of a cutting tool; and

FIG. 5 shows a perspective diagram of a spring body.

### DETAILED DESCRIPTION

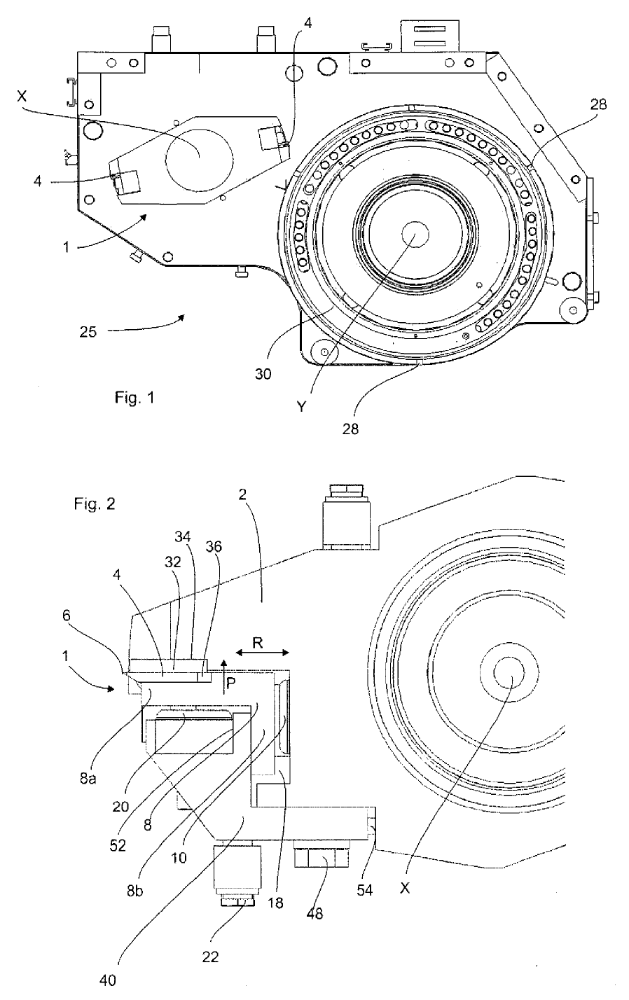

FIG. 1 shows a schematic diagram of an apparatus 25 according to the invention for cutting labels. Here, a cutting roller 30 is provided which initially carries an endless label strip. This cutting roller has a plurality of counter-cutting channels 28 which are distributed in the circumferential direction of the counter-cutting roller 30. Furthermore, this counter-cutting roller has suction devices for drawing the label onto the outer circumference of the counter-cutting roller 30. During operation, the counter-cutting roller 30 rotates in a predefined direction of rotation, here for example in the anticlockwise direction.

A cutting tool 1 according to the disclosure cooperates with the counter-cutting roller in order to cut the labels. More specifically, the rotation of the cutting rotor or housing 2 of the cutting tool 1 is synchronised with the rotation of the cutting roller in such a way that the cutting elements 4 in each case coincide with the counter-cutting channels during the movement, in order to cut the labels. The cutting tool 1 here has two cutting elements 4. The cutting tool is driven by a motor (not shown), for example, with a linear motor drive.

FIG. 2 shows a more detailed diagram of a cutting tool 1. This cutting tool 1 has a housing 2 which rotates about a rotation axis X. The housing may also be referred to in its entirety as the cutting rotor. The housing has a recess 18 for fitting a cutting element 4, which has a cutting edge 6. Arranged in this recess is a spring body 10 which is denoted in its entirety by 10 and spring-mounts the cutting element 4 in the direction R. Here, the spring body 10 is arranged inside the cutting element 4 in a radial direction relative to the rotation axis X. More specifically, the cutting tool 1 has a plurality of the illustrated spring bodies 10 which are arranged one behind the other in the direction of the rotation axis X, which extends perpendicular to the plane of the figure.

A support 8 on one side contacts the spring body 10, and on the other side of said support the cutting element 4 is fixedly arranged. This support 8 or the section 8a thereof thus serves as a clamping bracket for fixing the cutting element 4. The cutting element 4 is clamped between the support 8 and a clamping bracket 32. This clamping bracket 32 in turn rests in a recess 34 which is formed in the housing 2, and thus cannot move in the direction R. This clamping bracket 32 may be made from plastic; however, it may be made from metal, for example, carbide. The support 8 in turn has an edge 36 which likewise supports the cutting element 4 in the direction R, so that the cutting element is always spring-mounted together with the support 8 in the direction R. It would also be conceivable that further mutually engaging elements are provided, which couple the movement of the cutting element 4 to the movement of the support 8.

The section 8b of the support can move in the recess 18 in the direction R and contacts the first guide body 10. The support 8 can also move relative to the second spring body 20 in the direction R.

A further bracket 40 may be arranged fixedly on the support via a screw connection 48. A recess 52 is provided above this further bracket 40, in which recess a second spring body 20 is provided. This second spring body 20 holds the cutting element in the housing. More specifically, this second spring body 20, as soon as it is subjected to the action of compressed air, presses against the support 8 or more specifically against the section 8a of the support and thus presses the cutting element 4 in the direction P against the clamping bracket 32.

The spring bodies 20 and 10 are subjected to the action of compressed air via an air supply device 22. Here, the supply may be designed as a circuit or as a plurality of separate circuits, an individual control or adjustment of the air pressures then being possible.

On the whole, therefore, via the clamping bracket 23 and membranes of the second spring body 20, which is inserted in a holder 40, the cutting element 4 is securely clamped as soon as the second spring body 20 is subjected to the action of compressed air, i.e. as soon as air is supplied to a membrane of this second spring body 20. During operation, this membrane is continuously supplied with air, which is introduced through a rotary distributor into the rotating rotor or housing 2. The air passes to the spring body 20 via screw connections and hoses. In order to change the blade, the compressed air simply has to be switched off.

The holder 40 serves not only to hold the spring body 20 but also as a front stop for the support 8 and thus defines the extent to which the cutting element protrudes or is preloaded.

The position of the holder 40 relative to the support 2 is adjusted by means of adjusting screws 54. After adjustment, the holder 40 is fixed in place by a plurality of screws 48.

The first spring body 10, which likewise has a membrane continuously supplied with air and is arranged behind the support, has three functions. On the one hand, it serves to push the cutting element forwards from one step to the next. Furthermore, the cutting element is intended to be gently spring-mounted during the actual cutting operation and finally is also intended to generate the necessary cutting force. It is possible to increase the cutting force by changing the air pressure acting on the spring body 10. Instead of the air-filled spring body shown here, however, it would also be possible to use other adjustable spring elements, such as helical springs for example.

The arrangement of the spring bodies 20 gives rise to a clamping force of approximately between 200 and 1500 N. The spring force applied by the first spring body 10 lies in the range from about 500 N to about 3000 N.

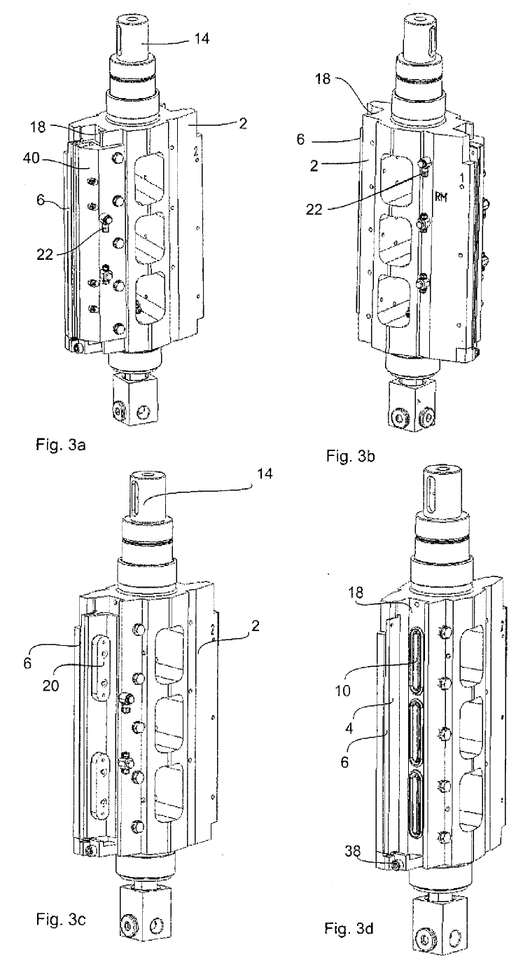

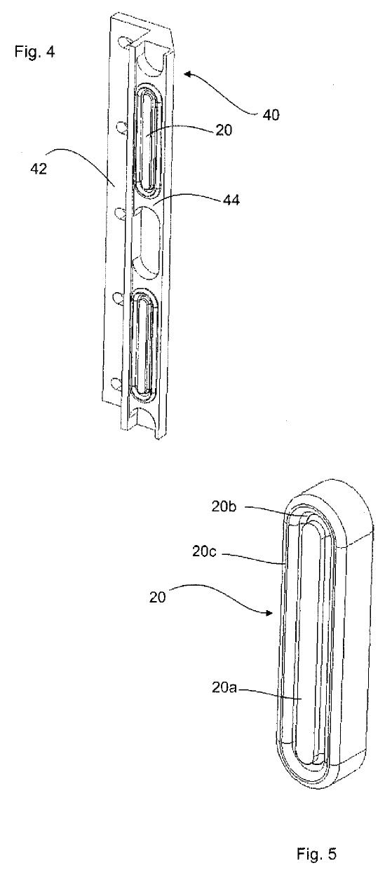

FIGS. 3a to 3d show several diagrams of a housing or rotor 2 according to the disclosure. In the diagram shown in FIG. 3a, the housing 2 is fully assembled, i.e. even the holder 40 has already been screwed onto the housing 2 and positioned. A corresponding second holder is located on the rear side (not shown) of the rotor 2, said holder being arranged in a rotatable manner via a shaft 14.

FIG. 3b shows one of the corresponding rear sides, wherein the pressure supply connections 22 are respectively shown both in FIG. 3a and in FIG. 3b.

The rotor 2 may have a rotationally symmetrical design in order to prevent imbalances during its rotation.

In FIG. 3c, the holder 40 has been removed so that the second spring bodies 20 located therebelow can be seen. As mentioned above, these second spring bodies 20 act between the holder 40 and the support 8 and thus give rise to a preloading of the cutting element 4 in the housing 2. Further spring bodies are provided here.

FIG. 3d shows a further diagram, wherein the support 8 has also been removed here. It is possible to see here the first spring bodies 10, wherein three such spring bodies 10 are provided here in the direction of the rotation axis. These first spring bodies 10 cause the support to be spring-mounted together with the cutting element in the radial direction.

FIG. 4 shows a perspective diagram of a holder 40. Provided in this holder are two spring bodies 20 which in FIG. 4 are subjected to the action of compressed air from behind. Reference 42 denotes a frame strip, by means of which the holder 40 can be screwed onto the housing 2. The spring bodies 20 are inserted in a support part 44.

FIG. 5 shows a spring body 20 or 10. This spring body 20 has a membrane 20a which is pushed outwards when subjected to the action of compressed air. A corresponding bead 20c, which together with the membrane forms a recess 20b, means that the membrane 20a can be extended out of the spring body 20.

It will be apparent to those skilled in the art that various modifications and variations can be made to the cutting tool for cutting labels of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. Cutting tool for cutting labels, comprising:
a housing rotatable about a rotation axis;
a cutting element detachably coupled with the housing, the cutting element having a cutting edge extending substantially in a direction parallel to the rotation axis, the cutting element being arranged such that it can move relative to the housing; and
a first spring body structured and arranged to cushion a movement of the cutting element in a radial direction of the housing.

2. Cutting tool according to claim 1, wherein the first spring body is arranged between two end sections of the cutting element in the direction of the rotation axis.

3. Cutting tool according to claim 1, wherein the spring body comprises a gas-filled spring element.

4. Cutting tool according to claim 1, wherein the cutting element is arranged in a recess provided on an outer circumference of the housing.

5. Cutting tool according to claim 1, wherein a support is provided between the cutting element and the first spring body, said support making contact with the cutting element and the first spring body.

6. Cutting tool according to claim 1, wherein the cutting tool has a second spring body which preloads the cutting element relative to the housing in a circumferential direction of the housing.

7. Cutting tool according to claim 6, wherein the second spring body comprises a gas-filled spring element.

8. Cutting tool according to claim 7, wherein a section of the support is arranged between the cutting element and the second spring body.

9. Cutting tool according to claim 6, wherein a section of the support is arranged between the cutting element and the second spring body.

10. Cutting tool according to claim 5, wherein the support has an L-shaped cross section.

11. Cutting tool according to claim 5, further comprising a supply device for supplying an element of the spring body with gas.

12. Cutting tool according to claim 11, wherein the supply device is configured such that it supplies the element of the spring body with gas continuously during an operating state.

13. Cutting tool according to claim 5, wherein at least one of the first and second spring bodies has a flexible membrane.

14. Cutting tool according to claim 1, wherein the first spring body has a flexible membrane.

15. Cutting tool according to claim 1, wherein the cutting tool has a plurality of first spring bodies arranged one behind the other in the direction of the rotation axis.

16. Cutting apparatus for cutting labels, comprising:
a cutting tool according to claim 1; and
a counter-cutting roller that cooperates with the cutting tool.
